(19) United States
(12) Patent Application Publication
(10) Pub. No.: US 2025/0236063 A1
(43) Pub. Date: Jul. 24, 2025

(54) HEATING DEVICE FOR PRODUCING DETERGENT METERING UNITS WITH IMPROVED PROPERTIES

(71) Applicant: HENKEL AG & CO. KGAA, Düsseldorf (DE)

(72) Inventors: Uwe TREBBE, Düsseldorf (DE); Niklas SIEPLER, Wuppertal (DE)

(21) Appl. No.: 18/853,571

(22) PCT Filed: Jan. 17, 2023
(86) PCT No.: PCT/EP2023/051001

§ 371 Date: Oct. 2, 2024

(30) Foreign Application Priority Data
Apr. 4, 2022 (EP) 22166466.7

(51) Int. Cl. B29C 51/42; B29C 51/10; B29L 31/00

(52) U.S. Cl. CPC B29C 51/421; B29C 51/10; B29C 2791/006; B29L 2031/712

(57) ABSTRACT

The invention relates to a heating device (1) which is designed to heat a packaging film in a deep drawing process, over the course of which the heated packaging film is molded into the cavity of a deep drawing mold. The surface region of the heating device (1) which is brought into contact with the film section to be molded into the cavity has at least one depression (50), the opening area (40) of which equals 40 to 95% of the opening area (40) of the cavity. The invention also relates to a deep drawing device comprising the aforementioned heating device (1).

The present invention relates to a device for heating packaging films, in particular for heating packaging films using deep-drawing methods.

Continuously changing requirements are placed on the forms of manufacture and supply of consumer goods. In the field of detergents or cleaning agents, for example, attention has been paid for some time to the more convenient dosing thereof by the consumer and the simplification of the work steps necessary to carry out a washing or cleaning method. A technical solution is provided by pre-portioned detergents or cleaning agents, for example film pouches comprising one or more receiving chambers for solid or liquid detergents or cleaning agents.

A trend relevant to the production of these film pouches is the miniaturization of these film pouches. In addition to higher consumer acceptance due to simplified handling, the background of this development is, in particular, sustainability aspects, for example with respect to the quantity of packaging materials used.

The film pouches described above are produced by multi-stage processes, in the course of which water-soluble film materials are molded in cavities, for example by the action of heat and negative pressure, filled, and subsequently sealed. While heating the films increases their plasticity, the force resulting from the negative pressure applied to the heated film causes the film to stretch and plastically deform. In this heating device, the film is not homogeneously stretched over its surface, but rather regions where it is highly stretched, for example in the edge region of the cavity, alternate with regions where it is less stretched. A deformed film in the form of a receiving container having a heterogeneous film thickness distribution is thus produced from a film material having a homogeneous film thickness. The more intensely the original film material is deformed, the more pronounced this heterogeneous film thickness distribution becomes. The intensity of the deformation generally increases, for example, with the number or depth of the receiving chambers that are molded into the receiving container.

In addition to other factors, both the film thickness distribution and the absolute film thickness determine the haptic, visual and mechanical properties of the film pouch. Film pouches having large differences in the film thickness are often perceived as less attractive. Film pouches having a low minimal film thickness deform more easily under their own weight than corresponding film pouches having a higher film thickness and appear limp. These film pouches withstand mechanical load to a lesser extent and dissolve too quickly when water is added. The two last-mentioned properties not only are relevant to film pouches in the area of production, transport, and storage but also in particular affect product safety, for example in the event of inadvertent oral consumption.

In order to increase the homogeneity of the wall thickness in the case of deep-drawing methods, the international application WO 2019/06448 A1 proposes a deep-drawing method in the course of which a temperature profile is applied to a flat film.

With the same objective, heating device using heating devices having a heterogeneous temperature distribution are proposed in European patent application EP2298536 A2 and international patent application WO 2020/1520441 A1.

However, these previously described solution approaches are complex in terms of equipment and are only suitable for high throughputs to a limited extent. Furthermore, the device, just as the changeover of corresponding deep-drawing lines, is costly.

Against this technical background, the object addressed by the application was that of providing a heating device for the production of portion units, which, with minimal equipment cost and with minimal use of film materials used for packaging purposes, facilitates the efficient production of portion units with maximum stability and an attractive appearance and haptics.

The application firstly relates to a heating device which is designed to heat a packaging film in a deep-drawing method, in the course of which the heated packaging film is molded in the cavity of a deep-drawing die, wherein the surface region of the heating device, which is brought into contact with the film portion to be molded in the cavity, has at least one depression, the opening area of which is 40 to 95% of the opening area of the cavity.

The heating device according to the invention enables, for example, the efficient production of detergent portion units. Due to the uniform thickness of the water-soluble film, these detergent portion units are characterized by high mechanical stability with minimal use of packaging means and attractive haptics and appearance.

The surface region of the heating device surrounding the depression is preferably designed to be planar. Particularly preferred materials for manufacturing the surface heating device are ceramic or metal, in particular aluminum.

Preferred heating devices have a metallic surface, in particular a metallic surface which comprises aluminum. Due to their heat-conducting properties, metallic heating device surfaces which consist of at least 70 wt. %, preferably at least 90 wt. %, particularly preferably at least 98 wt. %, and in particular completely of aluminum are preferred.

The planar surface regions of the heating device can be textured to control the heat transfer or to prevent adhesions. Such textured surfaces have, for example, visible or noticeable irregularities, such as grooves. The texture elements differ from the depressions, of course, with regard to their depth and their width. In preferred textured surface regions, the maximum depth of the texture elements is less than 0.5 mm, preferably less than 0.2 mm, and in particular less than 0.1 mm. The maximum depth corresponds to the maximum length of a distance, orthogonal to the opening area, between a point on the opening area and a point on the bottom surface of the texture element.

Preferred heating devices have a peripheral edging. The edging encloses the planar surface region and the depression formed in this surface region, or the depressions formed in this surface region. Preferably, at least four, preferably at least eight and in particular at least sixteen depressions are enclosed by the edging.

A film brought over the heating device is spaced apart from the heated surface by means of the edging. A contact between the film and the surface of the heating device thereby occurs only by a targeted application of force, for example by applying a negative pressure between the heating device surface and the film. As a result, the contact times between the heated surface and the film can be controlled in a targeted manner even at high process speeds. Since the described effect of this spacing is less pronounced at a low edging height, while the effect of the negative pressure used is reduced at a high edging height, the height of the edging is preferably 0.5 to 2 mm, particularly preferably 0.8 to 1.2 mm. An edging height of 1 mm is very particularly preferred.

In summary, a preferred method variant is characterized in that the surface region of the heating device that surrounds the depression has a planar design and is enclosed by a peripheral edging having a height of 0.5 to 2 mm, preferably of 0.8 to 1.2 mm.

With respect to the desired homogeneous film expansion, it has proven to be advantageous if the opening area of the at least one depression is smaller than the opening area of the cavity. In preferred methods, the opening area of the at least one depression is 50 to 90%, and in particular 60 to 80% of the opening area of the cavity.

In order to achieve homogeneous film expansion, it is furthermore advantageous to model the outline of the opening area of the depression on the outline of the opening area of the cavity. The two-dimensional shape of the opening area of a depression is referred to as a replication and resembles the two-dimensional shape of the opening area of the cavity, for example with respect to the number of corners present.

It is particularly preferred if the outline of the opening area of the depression is obtained from the outline of the opening area of the cavity by a reduction, wherein preferably reducing factors of 0.4 to 0.95, preferably of 0.5 to 0.9, and in particular of 0.6 to 0.8 are applied.

Preferred depressions have an opening area with a maximum diameter of 10 to 40 mm, preferably of 20 to 35 mm. The maximum depth of preferred depressions is 0.5 to 7 mm, preferably 0.8 to 4 mm. The maximum depth corresponds to the maximum length of a distance, orthogonal to the opening area, between a point on the opening area and a point on the bottom surface of the depression.

The depressions can have different three-dimensional shapes. In addition to the rim of the opening area, preferred depressions have at most one further rim. It is furthermore preferred if the depressions have no side surfaces orthogonal to the opening area. Rather, depressions which are delimited exclusively by their opening area and a bottom surface directly adjoining the opening area are preferred. Particularly preferred depressions have, for example, a hemispherical, compressed hemispherical, elongated hemispherical or a compressed and elongated hemispherical three-dimensional shape. The bottom surface can be flattened, for example in the form of a region plane-parallel to the opening area.

Preferred depressions are characterized by a bottom surface which continuously decreases from its rim to its lowest point. Of course, the depression can have more than one lowest point. For example, as described above, the depression can have a bottom surface that is partially plan-parallel to the opening area. In such an embodiment, the bottom surface has a continuous gradient between the rim of the depression and the rim of the plan-parallel region of the bottom surface.

The gradient can run linearly or nonlinearly. Both the absolute gradient and its relative course have proven to be relevant to the film thickness homogeneity that is achieved. Preferred depressions have a bottom surface which continuously decreases from its rim down to its lowest point and whose gradient on the shortest route from the rim down to the lowest point runs linearly over at least 10%, preferably 30% of the distance. For example, method variants with the use of depressions which have a bottom surface which continuously decreases from its rim down to its lowest point and whose gradient on the shortest route from the rim down to the lowest point runs linearly over 10 to 90%, preferably of 30 to 80% of the distance have proven to be advantageous.

It is preferred if the depression has a bottom surface which continuously decreases from its rim to its lowest point and whose gradient on the shortest route from the rim down to the lowest point changes at least at one point.

Preferably, the depression has a bottom surface which continuously decreases from its rim down to its lowest point and whose gradient on the shortest route from the rim down to the lowest point is 10 to 50%, preferably 15 to 40% over the entire distance.

The volume of preferred depressions is preferably from 1 to 8 ml, preferably from 1 to 6 ml.

The ratio of the maximum depth of the depression to the maximum depth of the cavity is preferably 2:3 to 1 to 5, particularly preferably 1:2 to 1:4. A corresponding ratio has proven advantageous both with regard to the homogeneity of the film thickness distribution and with respect to the process control.

The heating device according to the invention is particularly suitable for producing portion units having complex geometries or for portion units comprising more than one receiving chamber.

The surface of the heating device preferably has a planar design between two adjacent depressions associated with a portion unit. The minimum distance between two such adjacent depressions is preferably 0.5 to 4 mm, preferably 1 to 3 mm. The recesses can differ in terms of their maximum depth.

In a preferred embodiment, the two, three or four receiving chambers and consequently also the depressions associated with the receiving chambers in the heating device are arranged so as to surround one another at least in portions. Preferred heating devices have two, preferably at least three and in particular at least four depressions, one depression of which forms a central point around which the remaining depressions are arranged in a rotationally symmetrical manner.

As stated at the outset, the heating device preferably has a metallic surface. This preferably metallic surface in turn has depressions which, at minimal equipment cost and with minimal use of film materials used for packaging, enable the efficient production of portion units with maximum stability and attractive appearance and haptics.

These advantageous properties of the method according to the invention can be intensified by an at least partial coating of the surface of the heating device. It is particularly advantageous here to at least partially coat the surface of the heating device in the region of the depression. Like the depressions located in the surface, a corresponding coating influences the film thickness distribution of the receiving containers produced. It has proven advantageous in this context to coat the surface of the heating device over the entire surface in the region of the depression(s).

The coating can extend onto the surface of the heating device in the region of the depression(s) and the rim region surrounding the depression.

The coating of the heating device surface in the region of the depressions necessarily leads to an at least partial filling of the depression volume. In variants of the method according to the invention, the at least one depression is filled with a coating material to at least 60 vol. %, preferably at least 80 vol. %, and in particular completely.

The coating can cover 5 to 80%, preferably 10 to 70%, and in particular 20 to 50% of the surface region of the heating device which is brought into contact with the film.

Coating materials from the group of metals and polymers, in particular rubbers and silicones, are suitable as material for the coating. The coating with silicones is particularly preferred due to their heat resistance and moldability.

Preferred coating compositions have a lower thermal conductivity and/or a lower heat transfer coefficient than the heating device surface.

The thickness of the coating is preferably 100 to 4000 μm, and particularly preferably 200 to 2000 μm.

Any coatings can be joined to the base surface in various ways. Thus, adhesive joints are suitable for forming a lasting and temporally locally stable bond between the heating device surface and the coating agent. Clamping or plug connections are in turn preferably used in the cases in which a rapid exchangeability of the coating agents, for example due to wear or to the change in the process parameters, is sought.

In order to reduce the process duration and to ensure reproducible contact between a packaging film and the surface of the heating device, the film is preferably brought into contact with the heating device by means of a negative pressure. Furthermore, it is preferred to maintain the contact between the film and the heating device by maintaining a negative pressure.

In order to support the uniform formation of a negative pressure between heating device and water-soluble film, the surface of the heating device preferably has bores by means of which gas located between heating device and film can be discharged. These bores are preferably 60%, preferably 90%, in particular 95%, and very particularly preferably completely outside the depressions.

For reasons of process efficiency, it is preferred if the heating device has at least four, preferably at least sixteen, and in particular sixty-four depressions.

The present application also relates to a deep-drawing device comprising a heating device according to any one of the preceding points.

In order to increase method efficiency and to increase film thickness homogeneity, it has proven to be advantageous if the deep-drawing device comprises a deep-drawing die which is arranged below the heating device. The distance between the surface of the heating device and the surface of the deep-drawing die is preferably less than 10 mm, preferably less than 5 mm, in particular 0.1 to 2 mm, and particularly preferably 0.2 to 1 mm.

Furthermore, for reasons of method efficiency, it is preferred to arrange the heating device and the deep-drawing die in such a way that the cavity of the deep-drawing die, into which a portion of the heated packaging film is molded, is located opposite the opening area of the depression of the heating device which covers this portion of the packaging film during heating by the heating device.

This application provides, inter alia, the following subjects:
1. A heating device which is designed to heat a packaging film in a deep-drawing method, in the course of which the heated packaging film is molded in the cavity of a deep-drawing die, wherein the surface region of the heating device, which is brought into contact with the film portion to be molded in the cavity, has at least one depression, the opening area of which is 40 to 95% of the opening area of the cavity.
2. The heating device according to point 1, wherein the surface region of the heating device that surrounds the depression has a planar design.
3. The heating device according to any one of the preceding points, wherein the surface region of the heating device that surrounds the depression has a planar design and a textured surface (textured surface=visible or perceptible irregularities, such as grooves).
4. The heating device according to any one of the preceding points, wherein the surface region of the heating device that surrounds the depression has a planar design and is enclosed by a peripheral edging having a height of 0.5 to 2 mm, preferably of 0.8 to 1.2 mm.
5. The heating device according to any one of the preceding points, wherein the opening area of the depression is 50 to 90%, and in particular 60 to 80%, of the opening area of the cavity.
6. The heating device according to any one of the preceding points, wherein the outline of the opening area of the depression is modeled on the outline of the opening area of the cavity.
7. The heating device according to any one of the preceding points, wherein the outline of the opening area of the depression is obtained from the outline of the opening area of the cavity by a reduction factor of 0.4 to 0.95, preferably of 0.5 to 0.9, and in particular of 0.6 to 0.8.
8. The heating device according to any one of the preceding points, wherein the depression has an opening area with a maximum diameter of 10 to 40 mm, preferably of 20 to 35 mm.
9. The heating device according to any one of the preceding points, wherein the depression has a maximum depth (measured as an orthogonal distance between the opening area and the bottom surface of the depression) from 0.5 to 7 mm, preferably from 0.8 to 4 mm.
10. The heating device according to any one of the preceding points, wherein the depression has a hemispherical, compressed hemispherical, elongated hemispherical or compressed and elongated hemispherical three-dimensional shape.
11. The heating device according to any one of the preceding points, wherein the bottom surface of the depression is flattened and preferably runs plan-parallel to the opening area.
12. The heating device according to any one of the preceding points, wherein the depression has a bottom surface which continuously descends from its edge down to its lowest point.
13. The heating device according to any one of the preceding points, wherein the depression has a bottom surface which continuously descends from its edge down to its lowest point and whose gradient on the shortest route from the edge down to the lowest point runs linearly over at least 10%, preferably 30%, of the route.
14. The heating device according to any one of the preceding points, wherein the depression has a bottom surface which continuously descends from its edge down to its lowest point and whose gradient on the shortest route from the edge down to the lowest point runs linearly over 10 to 90%, preferably 30 to 80%, of the route.
15. The heating device according to any one of the preceding points, wherein the depression has a bottom surface which continuously decreases from its edge down to its lowest point and whose gradient on the shortest route from the edge down to the lowest point changes at least at one point.
16. The heating device according to any one of the preceding points, wherein the depression has a bottom surface which continuously decreases from its edge down to its lowest point and whose gradient on the shortest route from the edge down to the lowest point is 10 to 50%, preferably 15 to 40%, over the entire route.
17. The heating device according to any one of the preceding points, wherein the depression has a volume of 1 to 8 ml, preferably of 1 to 6 ml.
18. The ratio of the maximum depth of the depression to the maximum depth of the cavity is preferably 2:3 to 1 to 5, particularly preferably 1:2 to 1:4.
19. The heating device according to any one of the preceding points, wherein the heating device has at least two depressions which differ in terms of their maximum depth.
20. The heating device according to point 19, wherein the surface of the heating device between the depressions has a planar design.
21. The heating device according to either point 19 or point 20, wherein the surface of the heating device between the depressions has a planar design and the minimum distance between two depressions is 0.5 to 4 mm, preferably 1 to 3 mm.
22. The heating device according to any one of the preceding points, wherein the heating device has at least two, preferably at least three and in particular at least four, depressions, which surround one another at least in portions.
23. The heating device according to any one of the preceding points, wherein the heating device has at least two, preferably at least three and in particular at least four, depressions, one depression of which forms a central point around which the remaining depressions are arranged rotationally symmetrically.
24. The heating device according to any one of the preceding points, wherein the heating device has a metal surface.
25. The heating device according to any one of the preceding points, wherein the heating device has a metal surface which comprises aluminum.
26. The heating device according to any one of the preceding points, wherein the heating device has a metal surface which consists of up to at least 70 wt. %, preferably up to at least 90 wt. %, and particularly preferably up to at least 98 wt. % and in particular completely, of aluminum.
27. The heating device according to any one of the preceding points, wherein the surface of the heating device is coated at least in portions.
28. The heating device according to any one of the preceding points, wherein the surface of the heating device is coated at least in portions in the region of the depression.
29. The heating device according to any one of the preceding points, wherein the surface of the heating device is coated over the entire surface in the region of the depression(s).
30. The heating device according to any one of the preceding points, wherein the surface of the heating device is coated in the region of the depression(s) and also in the region of the edge region surrounding the depression.
31. The heating device according to any one of the preceding points, wherein the at least one depression is filled to at least 60 vol. %, preferably to at least 80 vol. %, and in particular completely with the coating material.
32. The heating device according to any one of the preceding points, wherein the surface of the heating device is coated at least in portions and the coating covers 5 to 80%, preferably 10 to 70%, and in particular 20 to 50% of the surface region of the heating device which is brought into contact with the film.
33. The heating device according to any one of points 27 to 30, wherein the coating material is selected from the group consisting of metals.
34. The heating device according to any one of points 27 to 30, wherein the coating material is selected from the group consisting of polymers.
35. The heating device according to any one of points 27 to 30, wherein the coating material is selected from the group consisting of silicones.
36. The heating device according to any one of points 27 to 30, wherein the coating material is selected from the group consisting of rubbers.
37. The heating device according to any one of points 27 to 36, wherein the coating has a thickness of 100 to 4000 μm, preferably of 200 to 2000 μm.
38. The heating device according to any one of points 27 to 37, wherein the coating has a low degree of thermal conductivity than the metal base surface.
39. The heating device according to any one of points 27 to 38, wherein the coating has a low heat transfer coefficient than the metal base surface.
40. The heating device according to any one of points 27 to 39, wherein the coating is joined to the base surface by means of an adhesive connection.
41. The heating device according to any one of points 27 to 39, wherein the coating is joined to the base surface by means of a clamping connection.
42. The heating device according to any one of points 27 to 39, wherein the coating is joined to the base surface by means of a plug connection.
43. The heating device according to any one of the preceding points, wherein the surface of the heating device has bores by means of which gas located between the heating device and film can be discharged.
44. The heating device according to any one of the preceding points, wherein 60%, preferably 90%, in particular 95%, and very particularly preferably all of the bores are arranged outside the depressions.
45. The heating device according to any one of the preceding points, wherein the heating device has at least four, preferably at least sixteen, and in particular sixty-four, depressions.
46. A deep-drawing device comprising a heating device according to any one of the preceding points.
47. The deep-drawing device according to point 46, wherein the deep-drawing device comprises a deep-drawing die which is arranged below the heating device.
48. The deep-drawing device according to any one of the preceding points, wherein the deep-drawing device comprises a deep-drawing die and the distance between the surface of the heating device and the surface of the deep-drawing die is less than 10 mm, preferably less than 5 mm, and in particular between 0.1 and 2 mm, particularly preferably between 0.2 and 1 mm.
49. The deep-drawing device according to any one of the preceding points, wherein the deep-drawing die is arranged such that the cavity of the deep-drawing die into which a portion of the heated packaging film is molded is located opposite the opening area of the depression of the heating device which covers this portion of the packaging film during heating by the heating device.

### EXAMPLES

A water-soluble polyvinyl alcohol film (thickness 88 μm) was heated by means of varying heating devices and subsequently formed by the action of a negative pressure to form a drop-shaped receiving chamber. The temperature of the heating plate was 120° C. With the exception of the heating device used, the process parameters used in the tests were identical.

The following two heating devices were used:

Heating device 1: completely planar heating plate (aluminum)

Heating device 2: heating plate (aluminum) with a depression (maximum depth 1 mm), the outline of which is adapted to the drop-shaped receiving chamber with a reduction factor of 0.8.

After the deep-drawing process, the film thickness in the receiving chambers was determined by optical methods (film thickness analyzer) along a cross section orthogonal to the longitudinal axis of the drop. The film thickness was measured in each case along the cross section at nine measuring points that are equidistant from one another.

### Film Thickness ([μM])

| | 1 | 2 | 3 | 4 | 5 | 6 | 7 | 8 | 9 |
|---|---|---|---|---|---|---|---|---|---|
| Heating | 34.6 | 29.6 | 27.1 | 24.4 | 25.9 | 24.7 | 24.1 | 27.1 | 33.3 |
| device 1 | | | | | | | | | |
| Heating | 36.6 | 34.1 | 32.0 | 35.0 | 35.0 | 34.6 | 25.9 | 33.7 | 43.8 |
| device 2 | | | | | | | | | |

The receiving chambers obtained by means of the heating plate provided with depressions are characterized by a higher film thickness when the starting film is identical. Portion units which were obtained by filling with a liquid detergent and subsequent sealing by means of a second water-soluble film had an improved mechanical stability.

1. A heating device which is designed to heat a packaging film in a deep-drawing method, in the course of which the heated packaging film is molded in the cavity of a deep-drawing die, wherein the surface region of the heating device, which is brought into contact with the film portion to be molded in the cavity, has at least one depression, the opening area of which is 40 to 95% of the opening area of the cavity.

2. The heating device according to claim 1, wherein the surface region of the heating device that surrounds the depression has a planar design and is enclosed by a peripheral edging having a height of 0.5 to 2 mm.

3. The heating device according to claim 1, wherein the outline of the opening area of the depression is modeled on the outline of the opening area of the cavity.

4. The heating device according to claim 1, wherein the outline of the opening area of the depression is obtained from the outline of the opening area of the cavity by a reduction factor of 0.4 to 0.95.

5. The heating device according to claim 1, wherein the depression has a hemispherical, compressed hemispherical, elongated hemispherical or compressed and elongated hemispherical three-dimensional shape.

6. The heating device according to claim 1, wherein the depression has a bottom surface which continuously descends from its edge down to its lowest point.

7. The heating device according to claim 1, wherein the depression has a volume of 1 to 8 ml.

8. The heating device according to claim 1, wherein the heating device has at least two depressions which differ in terms of their maximum depth.

9. The heating device according to claim 1, wherein the heating device has at least two depressions which surround one another, at least in portions.

10. The heating device according to claim 1, wherein the heating device has at least two depressions, one depression of which forms a central point around which the remaining depressions are arranged in a rotationally symmetrical manner.

11. The heating device according to claim 1, wherein the surface of the heating device is coated, at least in portions.

12. The heating device according to claim 1, wherein the surface of the heating device is coated over the entire surface in the region of the depression(s).

13. A deep-drawing device comprising a heating device according to claim 1.

14. The deep-drawing device according to claim 13, wherein the deep-drawing device comprises a deep-drawing die which is arranged below the heating device.

15. The deep-drawing device according to claim 13, wherein the deep-drawing device comprises a deep-drawing die and the distance between the surface of the heating device and the surface of the deep-drawing die is less than 10 mm.
